(19) United States
(12) Patent Application Publication
(10) Pub. No.: US 2009/0216550 A1
(43) Pub. Date: Aug. 27, 2009

(54) BUSINESS METHOD FOR PRESERVING THE VALUE OF BUSINESS ASSETS

(76) Inventor: Robert E. Sharp, Portland, OR (US)

Correspondence Address: CHERNOFF, VILHAUER, MCCLUNG & STENZEL, LLP, 601 SW Second Avenue, Suite 1600, PORTLAND, OR, 97204-3157, US

(21) Appl. No.: 12/372,684

(22) Filed: Feb. 17, 2009

Related U.S. Application Data
(63) Continuation of application No. 10/999,851, filed on Nov. 30, 2004.

(51) Int. Cl. G06Q 99/00

(52) U.S. Cl. 705/1

(57) ABSTRACT

A business method for preserving the value of business assets, and more particularly, the value of assets that are subject to associated license agreements.

### CROSS-REFERENCE TO RELATED APPLICATIONS

This application is a continuation of, and claims the benefit of priority to, U.S. patent application Ser. No. 10/999,851, filed Nov. 30, 2004, which is hereby incorporated by reference.

### BACKGROUND OF THE INVENTION

The present invention relates to a business method for preserving the value of business assets, and more particularly, the value of assets that are subject to associated license agreements.

Many businesses use equipment or other assets that are subject to license agreements. For example, a typical business may use computers, computer software, communications equipment, security equipment, and many other types of assets, the continued use of which is licensed. Often, this equipment, such as storage array servers and telephone systems may be quite expensive, and therefore entail a significant percentage of the assets of the owning business.

Over time, a business will want to replace worn equipment, upgrade to a newer model of equipment, change brands, etc. In that instance, it is often desirable for a business to sell its old equipment to recoup some of the cost of purchasing new equipment. Unfortunately, many of the licenses that are associated with the equipment to be sold include non-transferability provisions such that the purchaser of the equipment would either be unable to use the equipment itself, i.e. the hardware, or would be unable to use the software associated with the equipment without the purchaser obtaining a new license at considerable expense. The inability of an owner of this business equipment to transfer its associated license thus considerably degrades the resale value of the equipment, typically by at least 50%.

The minimal resale value of such equipment has a significant deleterious effect on industry. First, the significant expense of purchasing a new license for used equipment drives up the cost of entry into a market or business. Second, the lack of a significant resale value of old equipment acts as a disincentive to upgrade to new, more efficient equipment. Third, the lack of significant resale value for technology assets makes technology businesses vulnerable to economic downturns due to the relatively small amount of cash that can be raised, if needed, by selling those assets—i.e. technology businesses have a tendency to be undercapitalized. This often makes it difficult to persuade venture capitalists or lenders to invest in technology businesses because their investment will tend to be undersecured. Together, these adverse impacts act to drive up the costs of the goods and services provided by the users of such equipment.

What is desired, therefore, is a system that enhances the resale value of equipment or other assets that are subject to license agreements having transferability restrictions.

### SUMMARY OF THE INVENTION

A first embodiment of the present invention is a method comprising the steps of forming a legally recognized business entity, acquiring for said business entity at least one asset having an associated license agreement with a transferability restriction, and selling said business entity to a purchaser who wishes to acquire said at least one asset. Preferably, after the acquisition of the asset or assets by the business entity, the net worth of said business entity has total assets substantially equivalent to the whole of the assets it acquires.

A second embodiment of the present invention is a method comprising the steps of forming a plurality of legally recognized business entities, acquiring for each of the business entities at least one asset having one or more associated license agreements each with a transferability restriction, and selling a selective one or more of the business entities to a purchaser who wishes to acquire those assets. Preferably, after the acquisition of the assets by the respective business entities, the net worth of each business entity has total assets substantially equivalent to the whole of the assets it acquires.

A third embodiment of the present invention is a method for maximizing the resale value of a customer's licensed assets in which a request is received from a customer for the purchase of assets, each asset having at least one associated license agreement with a transferability restriction. The requested assets are categorized into one or more asset groups, each asset group having assets with associated one or more license agreements not associated with the assets of any other asset group. A number of legally recognized business entities equal to the number of said asset groups are formed and the assets of a respective one of the asset groups are acquired for each said business entity. The business entities are then transferred to the customer.

A fourth embodiment of the present invention is a business method for preserving the value of assets having associated one or more license agreements. The method may comprise the steps of forming a corporation, associating with the corporation one or more of the license agreements, and acquiring on behalf of said corporation at least one asset associated with the one or more license agreements associated with said corporation.

The foregoing and other objectives, features, and advantages of the invention will be more readily understood upon consideration of the following detailed description of the invention taken in conjunction with the accompanying drawings.

### BRIEF DESCRIPTION OF THE SEVERAL DRAWINGS

FIG. 1 shows a diagram illustrating one embodiment of the present invention.

FIG. 2 shows a diagram illustrating a second embodiment of the present invention.

FIG. 3 illustrates technology assets that have been improved by the embodiments shown in any of FIGS. 1-2.

### DETAILED DESCRIPTION OF PREFERRED EMBODIMENTS

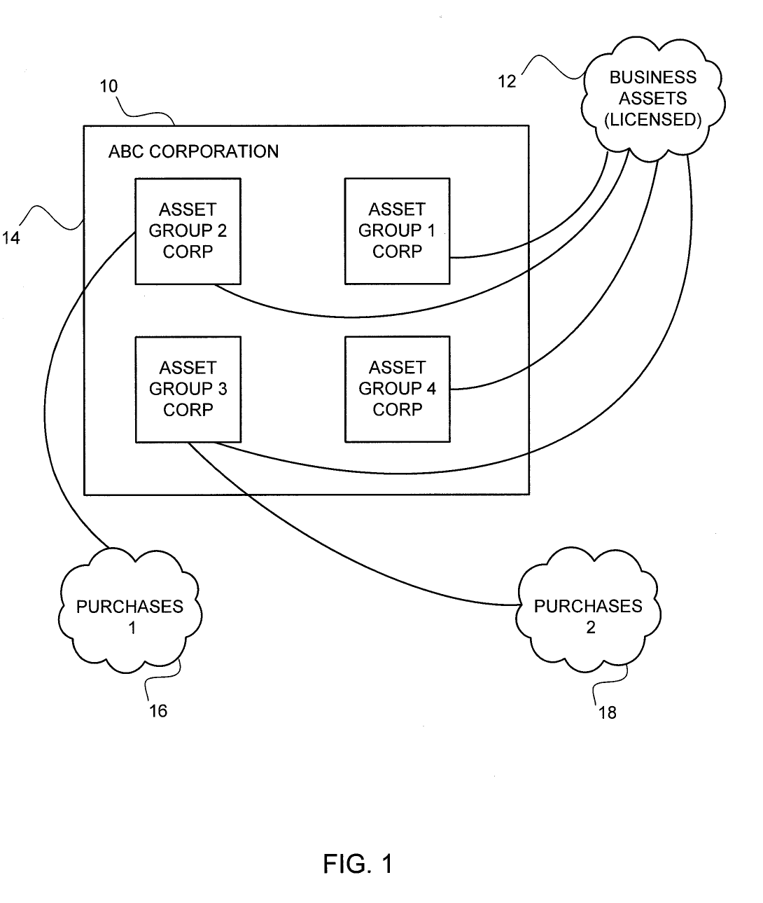

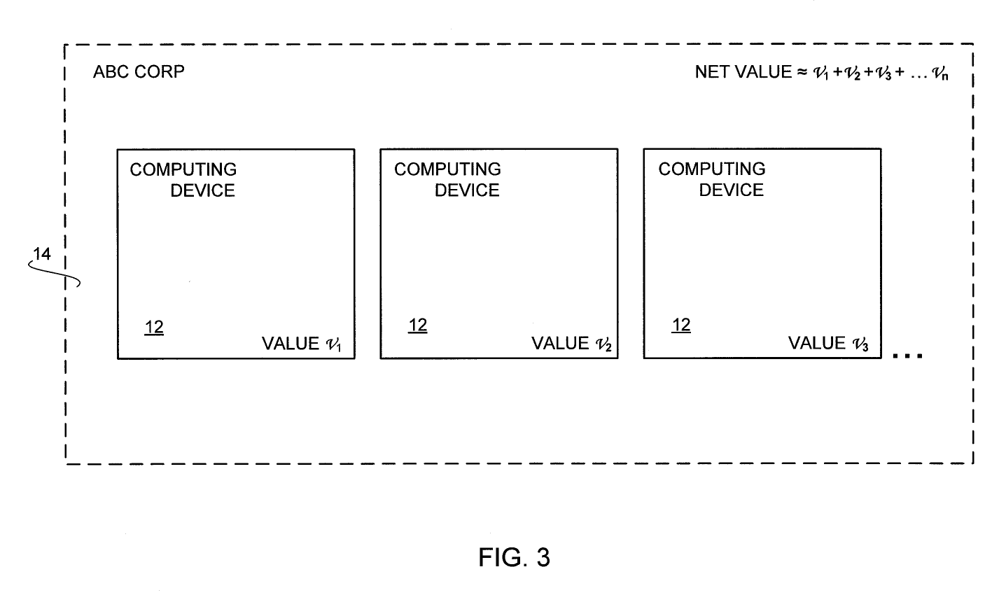

FIG. 1 shows a business 10 structured in accordance with the method of the present invention. Though FIG. 1 illustrates a corporation 10, any other type of business may employ the disclosed method, such as a partnership, a limited liability partnership, or an individual. The business 10 may own, control, or use a plurality of business assets 12 subject to one or more license agreements. Though the business assets 12 will typically be technology assets (as shown in FIG. 3) such as computers, servers, software, etc., the assets 12 may be any other type that has one or more associated license agreements. Such license agreements are usually associated with the use of plural items or instances of a single type of business asset. For example, a license agreement may be associated with the use of a specified number of servers, or telephones having proprietary software, etc. Typically, a single license agreement will cover both the use of the hardware and associated software, but sometimes separate license agreements will be crafted for the use of the hardware and the software, particularly if different vendors are involved.

As things currently exist, any of these license agreements that have provisions prohibiting or otherwise restricting the transfer of the licenses would significantly degrade the resale value of the equipment covered by the license agreements. The business 10, however, as disclosed in FIG. 1 has formed one or more corporations 14 and acquired the licensed assets 12 for the one or more corporations 14. When it is desired to sell the licensed assets 12 to a purchaser 16 or 18, the business 10 simply sells the corporation 14.

A business 10 structured as shown in FIG. 1 has the advantage of being able to realize a greater resale value of its licensed assets 12 than such existing businesses. Because the licenses 12 are owned by the corporations 14, the licenses 12 are unaffected by the transfer of the corporations 14 and therefore the purchaser 16 and/or 18 may use the purchased assets 12 without acquiring a new license. For that reason, a purchaser 16 and/or 18 would be willing to pay a significantly higher price for these assets than if the purchaser would have to acquire a new license to use the purchased assets.

Though FIG. 1 shows corporations 14 that acquire the licensed assets 12, other business structures or legal entities may also be employed, such as limited liability partnerships, etc. Furthermore, the corporations 14 may be formed either prior to the acquisition of the respective licensed assets 12 or substantially concurrently with the acquisition of the licensed assets.

In some embodiments of the present invention, to achieve the greatest flexibility in selling dated licensed assets 12, each of the corporations 14 will preferably have total assets substantially equivalent to the whole of the licensed assets 12 it respectively acquires. That is to say, if a corporation 14 were, in addition to the licensed assets 12 respectively acquired by the corporation 14, to also acquire an asset substantially unrelated to the operation of the business 10, such that the sale of that unrelated asset along with the sale of the licensed assets 12 held by the corporation 14 would either not significantly alter the selling value of the corporation 14 compared to its selling value without the unrelated asset or not significantly affect the continued operation of the business 10 using replacement assets for those sold with the corporation 14, excepting the unrelated asset, the corporation 14 would still have total assets substantially equivalent to the whole of the licensed assets 12 it respectively acquires.

Preferably, the value of the licensed assets 12 of the corporation 14 will exceed eighty percent of the total value of the corporation 10. More preferably, the value of the licensed assets 12 of the corporation 14 will exceed ninety percent of the total value of the corporation 14.

In a simple embodiment, the business 10 may include only a single corporation 14 that has acquired all of its licensed assets 12. In some instances, and particularly if the business 10 is using many types of assets subject to a number of license agreements, it may be desirable to form a plurality of corporations 14 such that the assets 12 may be divided among the corporations 14 in a manner that achieves the greatest flexibility in selling selected portions of the assets 12. Preferably, each of the corporations 14 is assigned assets associated with either a single license agreement or a series of related license agreements such that the license agreement or agreements associated with one corporation 14 are not associated with the assets of any other corporation 14. In this manner, the business 10 may sell a selected portion of its assets 12 by selling a selected one or more of the corporations 14.

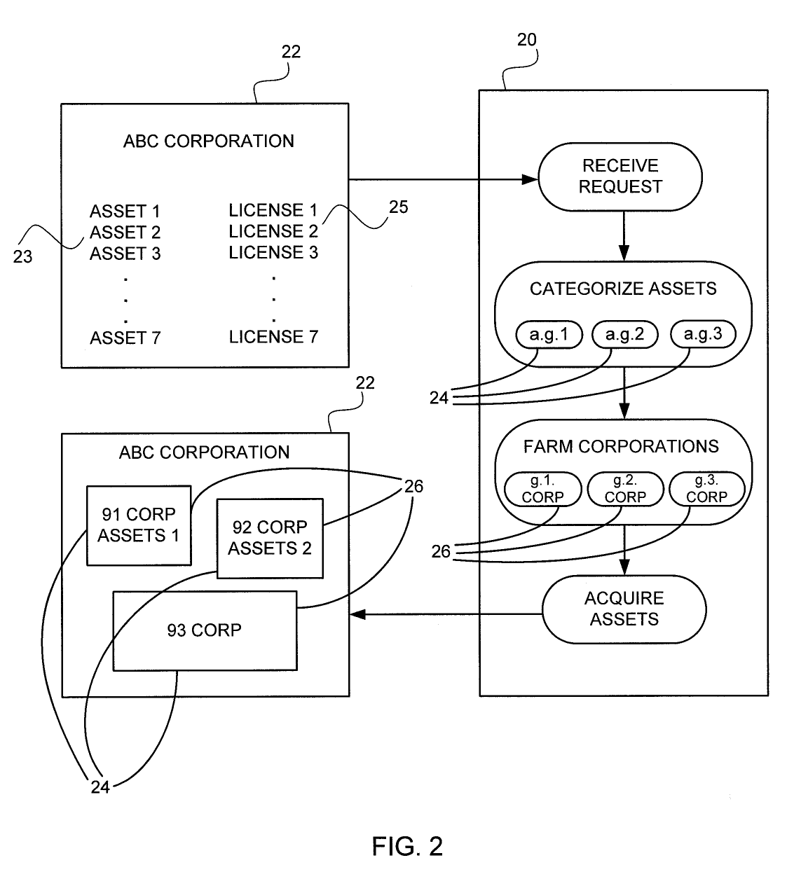

Referring to FIG. 2, a vendor business 20 may provide asset structuring services to assist customers in structuring their businesses to maximize the resale value of assets subject to license agreements. In this embodiment, the vendor business 20 may receive a request from a customer business 22 to acquire specified assets 23 subject to one or more license agreements 25. Upon receipt of this request, the vendor business 20 may preferably categorize the assets 23 into asset groups 24 that each have an associated license agreement or set of related license agreements that together license the use of assets within their respective asset groups, but not within the asset groups associated with other license agreements.

Once the assets 23 have been categorized into a number of asset groups, the vendor business 20 forms a number of corporations or other business entities 26. The respective corporations 26 then acquire the assets of a selected one of the asset groups 24, along with their associated license agreements. The corporations 26 are then transferred to the purchaser corporation 22.

In an alternate embodiment, the vendor business 20 may receive a request from a customer business 22 to acquire specified assets 23 subject to one or more license agreements 25. Upon receipt of this request, the vendor business 20 may preferably categorize the assets 23 into asset groups 24 that each have an associated license agreement or set of related license agreements that together license the use of assets within their respective asset groups, but not within the asset groups associated with other license agreements.

Once the assets 23 have been categorized into a number of asset groups, the vendor business 20 forms a number of corporations or other business entities 26 on behalf of the customer business 22. The respective corporations 26 then acquire the assets of a selected one of the asset groups 24, along with their associated license agreements.

In another embodiment, a business 10 may form a corporation 14 and acquire licensed assets 12 on behalf of the corporation 14. The business 10 then leases 15 to a customer the corporation 14 along with its licensed assets. When the lease expires or is otherwise terminated, the business 10 may lease the corporation 14 to another customer.

The terms and expressions that have been employed in the foregoing specification are used therein as terms of description and not of limitation, and there is no intention in the use of such terms and expressions of excluding equivalence of the features shown and described or portions thereof, it being recognized that the scope of the invention is defined and limited only by the claims that follow.

The terms and expressions which have been employed in the foregoing specification are used therein as terms of description and not of limitation, and there is no intention in the use of such terms and expressions of excluding equivalents of the features shown and described or portions thereof, it being recognized that the scope of the invention is defined and limited only by the claims which follow.

1-45. (canceled)

46. In combination with a business entity having a net value, at least one machine, each said machine comprising:
(a) a technology asset having electronic circuitry capable of executing instructions provided by software resident in a memory of said technology asset, said technology asset having an associated book value included in said net value of said business entity, said software subject to a license agreement having a transferability restriction; where
(b) said net value of said business entity is substantially equal to the sum of each said associated book value of said at least one machine.

59-60. (canceled)

47. The combination of claim 46 where said transferability restriction prohibits the transfer of said license.

48. The combination of claim 46 where said license agreement encompasses the software resident on all of said at least one machine.

49. The combination of claim 46 having a plurality of said machines, where the software resident on each said machine is subject to a respective license agreement different from that of at least one other of said plurality of machines.

50. The combination of claim 46 where said business entity is the licensee under said license agreement.

51. In combination with a first business entity having a first net value and a second business entity having a second net value, a plurality of machines comprising:
(a) a first set of technology assets, each technology asset in said first set having electronic circuitry capable of executing instructions provided by first software resident in a memory of said technology asset, said first software subject to a first license agreement having a transferability restriction, and said first set of technology assets having an associated collective book value, included in said net value of said first business entity, that is substantially equal to said first net value, and
(b) a second set of technology assets, each technology asset in said second set having electronic circuitry capable of executing instructions provided by second software resident in a memory of said technology asset, said second software subject to a second license agreement having a transferability restriction, and said second set of technology assets having an associated collective book value, included in said net value of said second business entity, that is substantially equal to said second net value.

52. The combination of claim 51 where each of said first and second business entities, respectively, are corporations.

53. The combination of claim 51 where said first set of technology assets are purchased by said first business entity and said second set of technology assets are purchased by said second business entity.

54. The combination of claim 51 where said transferability restriction associated with each of said first and second license agreements prohibits the transfer of said license.

55. The combination of claim 51 where said first license agreement encompasses the software resident on all of said first set of technology assets, and said second license agreement encompasses the software resident on all of said second set of technology assets.

56. The combination of claim 51 where the software resident on each said machine in said first set of technology assets is subject to a respective instance of said first license agreement, and the software resident on each said machine in said second set of technology assets is subject to a respective instance of said second license agreement.

57. The combination of claim 51 where said first business entity is the licensee under said first license agreement and said second business entity is the licensee under said second license agreement.

58. The combination of claim 46 where said at least one machine is purchased by said business entity.
